(19) United States
(12) Patent Application Publication
(10) Pub. No.: US 2001/0027482 A1
(43) Pub. Date: Oct. 4, 2001

(54) Information search and display apparatus

(76) Inventors: Chihiro Ono, Tokyo (JP); Satoshi Nishiyama, Saitama (JP); Masaru Sugano, Tokyo (JP); Yasuhiro Takishima, Tokyo (JP); Hiroyuki Kanemitsu, Gotenba-shi (JP); Tomoyasu Harada, Toyota-shi (JP)

Correspondence Address: ARMSTRONG,WESTERMAN, HATTORI,, MCLELAND & NAUGHTON, LLP, 1725 K STREET, NW, SUITE 1000, WASHINGTON, DC, 20006, US

(21) Appl. No.: 09/777,010

(22) Filed: Feb. 6, 2001

(30) Foreign Application Priority Data
Feb. 10, 2000 (JP) 2000-33697

(51) Int. Cl. G06F 15/16

(52) U.S. Cl. 709/219; 709/218

(57) ABSTRACT

The present invention provides an information search and display apparatus capable of dealing with information provided in various data formats from a plurality of different media in an integrated manner. The present invention comprising a push type information interface for inputting push type information provided from a push type information distribution medium, a pull type information interface for inputting pull type information and summaries of the pull type information from a pull type information distribution medium, summary extraction means for extracting summaries from said respective inputted push type information, summary storage means for storing said extracted summaries, search condition input means for inputting search conditions, summary download means for downloading summaries of pull type information satisfying said search conditions through said pull type information interface, the summaries described in said predetermined common format, summary search means for searching summaries satisfying said search conditions from the summaries registered in said summary storage means, and summary list display means for displaying a list of said searched summaries and the summaries satisfying said search conditions and downloaded from the pull type information distribution medium.

### BACKGROUND OF THE INVENTION

1. Field of the Invention

The present invention relates to an information search and display apparatus for searching and displaying desired information from information provided in various formats utilizing a plurality of different media. The present invention particularly relates to information search and display apparatus capable of dealing with various information in an integrated manner.

2. Description of the Related Art

In this multimedia age, various types of information are provided from a plurality of different media in unique formats, and various viewers are required to view and search the respective information.

It is impossible to search desired information both in WWW pages on the Internet where the information is represented by HTML format and in broadcast where the information is represented by other formats such as XML and MHEG format. Besides, search results cannot be displayed in an integrated manner. An operator is required to understand the formats of information provided from the respective media and to individually search and display the information using their individual dedicated viewers.

### SUMMARY OF THE INVENTION

It is, therefore, an object of the present invention to provide an information search and display apparatus capable of dealing with information provided in various data formats from a plurality of different media without making an operator feel the difference of media or data format.

The present invention comprising a push type information interface for inputting push type information provided from a push type information distribution medium, a pull type information interface for inputting pull type information and summaries of the pull type information from a pull type information distribution medium, summary extraction means for extracting summaries from said respective inputted push type information, summary storage means for storing said extracted summaries, search condition input means for inputting search conditions, summary download means for downloading summaries of pull type information satisfying said search conditions through said pull type information interface, the summaries described in said predetermined common format, summary search means for searching summaries satisfying said search conditions from the summaries registered in said summary storage means, and summary list display means for displaying a list of said searched summaries and the summaries satisfying said search conditions and downloaded from the pull type information distribution medium.

According to the above-stated features, it is possible to describe the summaries of various types of information which have different formats and different transmission methods and which cannot be displayed on a common viewer, in the same manner, to display a list of the summaries of the respective information using a single viewer. Thus, it is possible to search and display the contents of various information having different formats and different transmission methods with a simple constitution.

### BRIEF DESCRIPTION OF THE DRAWINGS

FIG. 1 is a block diagram of an information search and display apparatus in one embodiment according to the present invention;

FIG. 2 is a flow chart showing the operation of this embodiment;

FIG. 3 is a flow chart showing a display example of a main menu;

FIG. 4 shows a display example of a summary list;

FIG. 5 shows a display example of a search condition change screen;

FIG. 6 shows a display example of a selected summary;

FIG. 7 shows a display example of information corresponding to the selected summary;

FIG. 8 shows a display example of a simple map that is part of information;

FIG. 9 shows a display example of a topic selection screen;

FIG. 10 shows a display example of a summary list;

FIG. 11 shows a display example of a selected summary; and

FIG. 12 shows a display example of information corresponding to the selected summary.

### DESCRIPTION OF THE PREFERRED EMBODIMENT

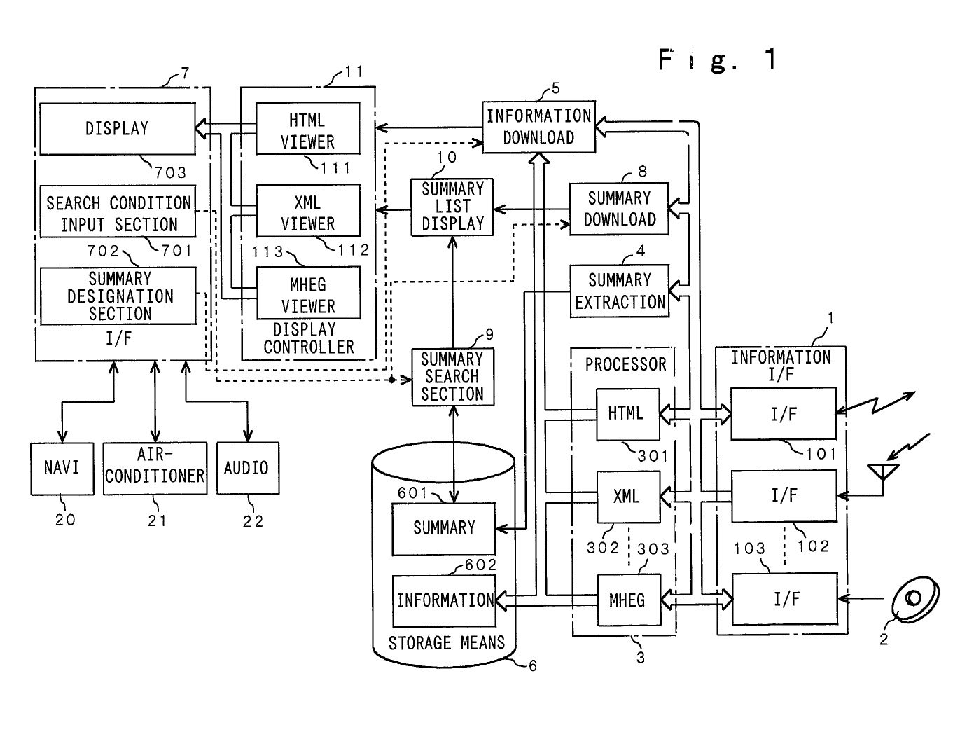

FIG. 1 is a block diagram showing the main constitution of an information search and display apparatus in one embodiment according to the present invention. Description will be given hereinafter while taking a case where the present invention is applied to an on-vehicle system as an example.

An information interface (I/F) 1 includes a plurality of interfaces specific to the formats of received information such a communication input/output I/F 101, a broadcast I/F 102 and a disk I/F 103.

The communication input/output I/F 101 is connected to an information providing source utilizing a public line or the Internet serving as a pull type information distribution medium for selectively transmitting information in accordance with user's demand through charged wireless communication, and collects various types of information (pull type information) and summaries thereof. The broadcast I/F 102 receives broadcast wave that is a push type information distribution medium for one-way transmitting information free of charge, and collects various types of information (push type information) and summaries thereof. The disk I/F 103 collects various types of information (pull type information) and summaries thereof from a disk medium 2, such as a CD-ROM or a DVD-ROM, which is a pull type information distribution medium.

A user interface (I/F) 7 includes a search condition input section 701 for allowing an operator to input search conditions for specifying desired information, a display 703 displaying a summary or information satisfying the search conditions, and a summary designation section 702 designating a summary corresponding to the desired information from many summaries displayed as a summary list on the display 703.

The user I/F 7 in this embodiment also functions as the input/output I/F for a car navigation system 20, air-conditioner system 21 and an audio system 22. An operation section for controlling the respective systems also functions as the operation system for the search condition input section 701, the summary designation section 702, key switches and the like.

An information processor 3 stores or overwrites information inputted through the information interface 1 in the information storage area 602 of a storage device 6. The information processor 3 in this embodiment includes an HTML processor 301 for processing information described in an HTML format, an XML processor 302 for processing information described in an XML format, and an MHEG processor 303 for processing information described in an MHEG format.

A summary extraction section 4 extracts summaries described in a predetermined format (e. g., XML format) common to the information from the respective information inputted through the information interface 1. Information to be downloaded in this embodiment is described in their peculiar formats including HTML, XML and MHEG formats. The respective information includes summaries indicating the summaries of the contents of the information. The summaries are described in a common format. The summary extraction section 4 extracts summaries described in the common format from decoded information, and stores the extracted summaries in the summary storage area 601 of the storage device 6.

Search conditions for specifying desired information are inputted from the search condition input section 701 of the user I/F 7 by an operator. A summary download section 8 searches and downloads the summary of information satisfying the search conditions inputted from the search condition input section 701, from the information providing source utilizing a public line, the Internet or the disk medium 2 serving as the pull type information distribution medium through the respective interfaces 101,103.

The summary search section 9 searches a summary satisfying the search conditions from the summaries registered in the summary storage area 601 of the storage device 6. A summary list display section 10 integrates a summaries newly downloaded by the summary download section 8 from the pull type information distribution medium and those searched by the summary search section 9 from the summary storage area 601 with one another, converts the integrated summaries into a summary list and outputs the list to a display controller 11.

The display controller 11 includes an HTML viewer 111 for displaying information (and summaries thereof) described in the HTML format, an XML viewer 112 for displaying information (and summaries thereof) described in the XML format and an MHEG viewer 113 for displaying information (and summaries thereof) described in the MHEG format. If the summary list is described in the XML format, the display controller 11 starts the XML viewer 112 and displays the summary list on the display 703.

The summary designation section 702 of the user interface 7 selects desired information by designating one of the summaries on the list displayed on the display 703. If information corresponding to the designated summary is registered in the information storage area 602 of the storage device 6, the information download section 5 reads and outputs the registered information to the display controller 11. If the information corresponding to the designated summary is pull type information which is not registered yet, the information download section 5 newly searches and downloads the information from the information providing service utilizing the public line, the Internet or the disk medium serving as the pull type information distribution medium through the respective interfaces 101,103, and outputs the new information to the display controller 11.

Initially, the information already registered in the information storage area 602 is only the push type information one-way transmitted from the push type information distribution media and stored therein. As described above, the information newly searched and downloaded from the pull type information distribution media are also successively stored and consumed as registered information thereafter.

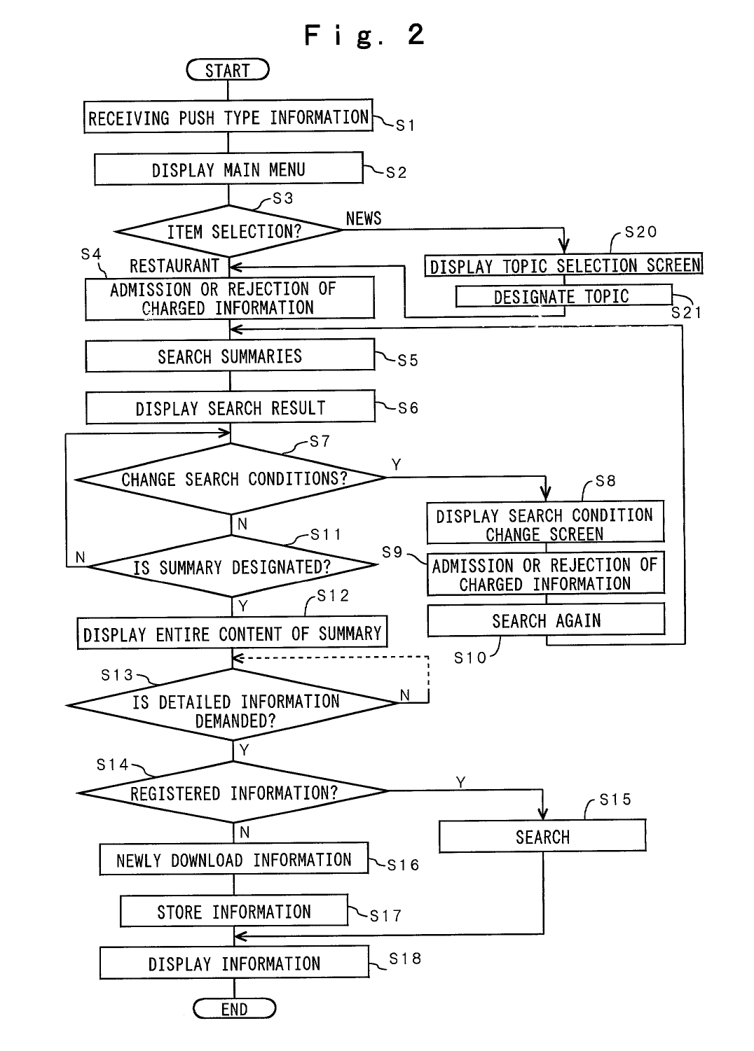

A search operation in this embodiment will be described in detail with reference to a flow chart shown in FIG. 2. In this embodiment, an operator is charged (with communication cost for connection to the public line or the Internet) if receiving information providing service utilizing the public line through the communication input/output I/F 101 or downloading information on the Internet, and not charged if downloading information through the broadcast I/F 102 and the disk I/F 103.

When a main switch, which is not shown, is turned on, the reception of information one-way transmitted from the push type information distribution medium (or broadcast in this embodiment) starts in a step S1. The information is sequentially inputted through the broadcast I/F 102. In the information processor 3, processors 301, 302 and 303 corresponding to the respective formats of the inputted information encode the information and sequentially store the encoded information in the information storage area 602 of the storage device 6. At the same time, the summary extraction section 4 decodes the received information, extracts the summaries described in a common format (e.g., XLM format) and stores the extracted summaries in the summary storage area 601 of the storage device 6. The reception and storage of the push type information as well as the extraction and storage of the summaries thereof are continuously carried out.

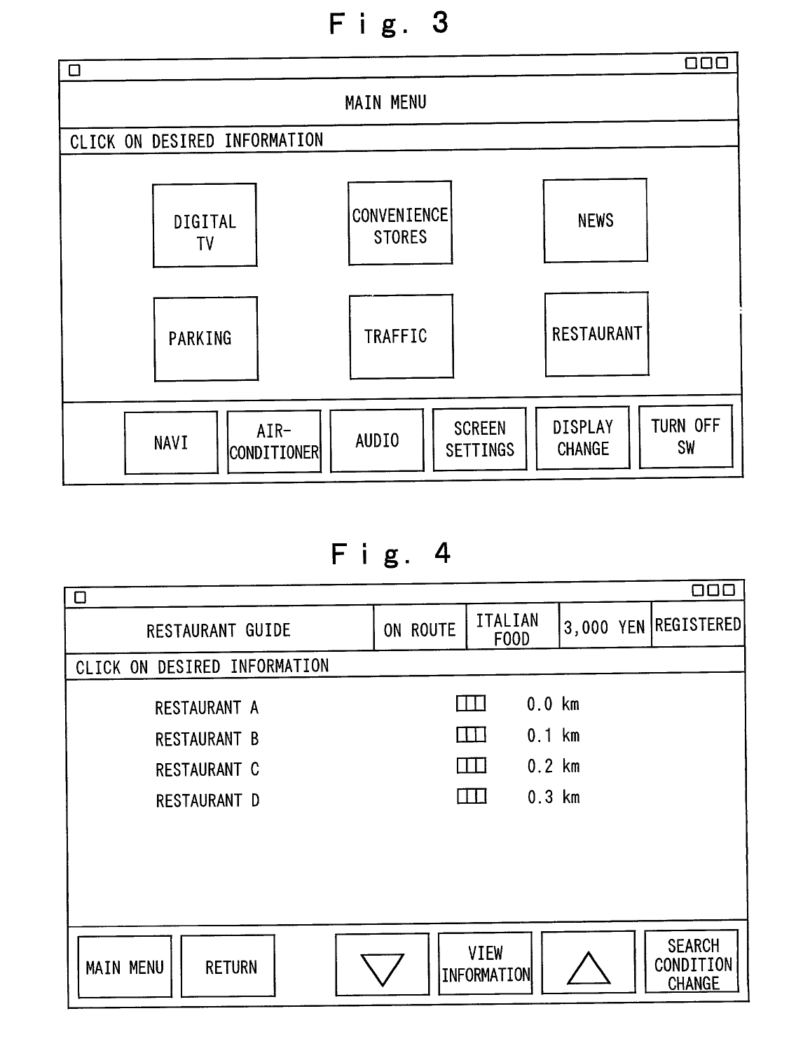

In a step S2, a main menu shown in FIG. 3 is displayed on the display 703 so that the operator can select an item. On the main menu in this embodiment, an icon “Digital TV” for selecting the view of a digital television, an icon “Convenience store” for selecting the search of convenience stores, an icon “News” for selecting the view of news, an icon “Parking” for selecting the search of parking, an icon “Traffic information” for selecting the view of traffic information and an icon “Restaurant guide” for selecting the search of restaurants are displayed.

On the lower part of a screen, an icon “NAVI” for starting car the navigation system 20, an icon “Air-conditioner” for displaying the operation screen of the air-conditioner 21, an icon “AUDIO” for displaying the operation screen of the audio 22, an icon “Screen Settings” for screen settings, an icon “Display Change” for changing a display content, and an icon “Turn off SW” for turning off icon display are displayed.

In a step S3, when the operator selects “Restaurant guide” as a search item, the processing moves to a step S4 so as to search restaurants. When the operator selects “News”, the processing moves to a step S20 to be described later. Operations for selecting the other items are the same as that for selecting “Restaurant guide” or “News” described in this embodiment, which description will not be, therefore, given herein.

When the icon “Restaurant guide” is selected, a message for selecting whether to admit or reject the download of charged information is displayed on the display 703 in a step S4. If the operator searches information including those which cannot be downloaded without using charged wireless communication such as information provided through the public line and information on the Internet, the operator registers admission to download charged information. If searching only the broadcast information transmitted free of charge or information stored in the on-vehicle CD-ROM, DVD-ROM or the like, the operator registers rejection to download charged information.

In a step S5, the search of restaurants is executed based on standard search conditions. In this embodiment, the standard conditions for searching restaurants are “on route”, “Italian food” and “price range of 3,000 yen per head”. “On route” means only the shops existing on a route (and the neighborhood thereof) connecting a destination to preset in the car navigation system 20 to a present location are to be searched.

When the search of summaries starts, the summary search section 9 searches the summaries of restaurant information stored in the summary storage area 602 of the storage device 6. The summary download section 8 newly downloads the summaries of restaurant information through the interface 1. At this moment, if the download of charged information is prohibited, the summary download section 8 downloads summaries only through the disk I/F 103. If the download of charged information is admitted, summaries provided by utilizing the public line or those on the Internet are downloaded through the communication input/output I/F 101 in addition to the disk input interface.

In a step S6, the summaries searched by the summary search section 9 and those newly downloaded by the summary download section 8 are converted into a list by the summary list display section 10. The resultant summary list is displayed on the display 70 as a search result list by the display controller 11 as shown in FIG. 4.

The search result list shows not only names of restaurants, distances from the present location to the restaurants but also types of foods, i.e., Japanese food and Italian food by adding the national flag of corresponding countries. On the upper edge of the screen, the search conditions of this time, i.e., “On route”, “Italian food”, “3,000 yen” and “Registered (which means only free information are to be searched)” are displayed.

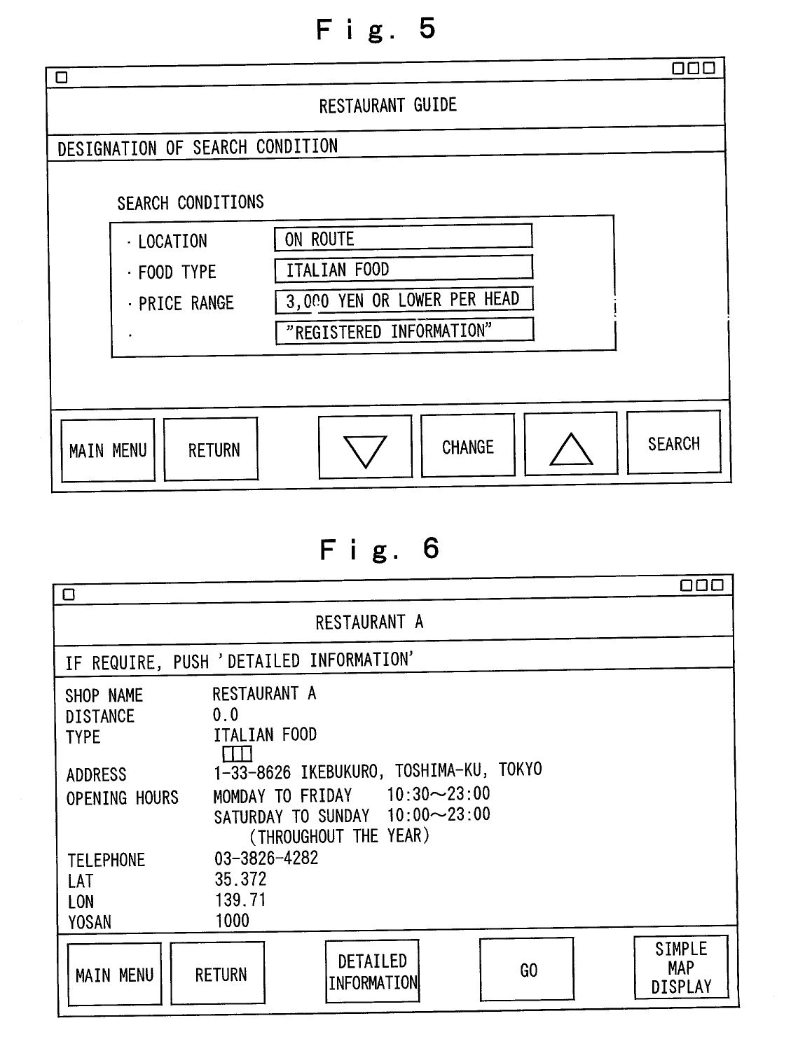

In a step S7, referring to the display screen, the operator judges whether or not a restaurant the detailed information of which the operator desires to view is on the list. If the desired restaurant is not on the list, the operator clicks on an icon “Search condition change” for displaying a screen for changing search conditions. In a step S8, a screen for setting and changing search conditions is displayed on the display 703 as shown in FIG. 5. The operator changes “Search location”, “Food type”, “Price range” and a search range (unregistered charged information/registered free information).

When the operator cancels the condition of “Registered information” from search conditions, a screen for selecting whether to admit or reject the download of charged information is displayed in a step S9. In a step S10, search is executed again based on the changed search conditions.

Then, if the restaurant which the operator desires to view in detail is on the list in the step S6 and the operator clicks on a desired summary in a step 11, the entire content of the selected summary is displayed on the display 703 as shown in FIG. 6 in a step S12.

In a step S13, it is determined whether or not the detailed information on the restaurant is demanded. If the operator clicks on the icon “Detailed information” shown in FIG. 6, it is then determined whether or not the information is already registered in the information storage area 602 of the storage device 6 in a step S14. If the information is registered, the information download section 5 searches the information storage area 602 in a step S15.

If the demanded information is not registered in the information storage area 602, the information download section 5 downloads information from externally through the interface 1 in a step S16. The downloaded information is stored in the information storage area 602 in a step S17 and the information is consumed as registered information thereafter.

In a step S18, the information searched or newly downloaded is fed from the information download section 5 to the display controller 11 and outputted to the display 703 by the viewer corresponding to the format of the information. Namely, if information to be displayed is described in the HTML format, the information is processed by the HTML viewer 111.

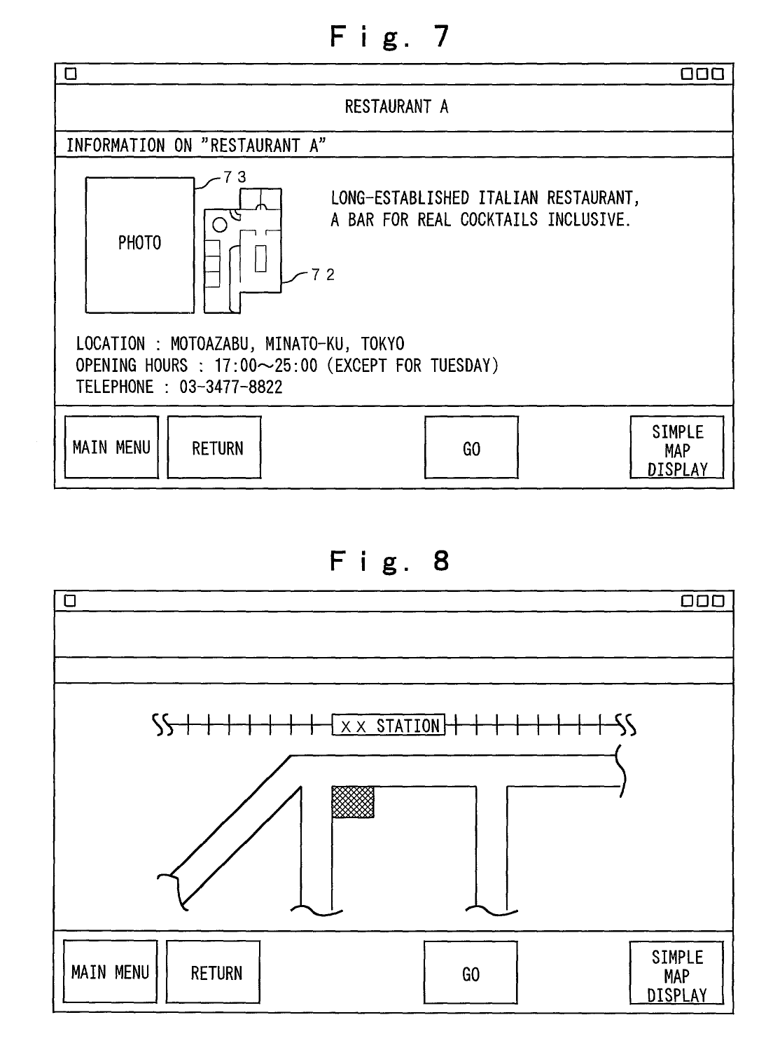

FIG. 7 shows a display example of the above-stated information. An introduction 71, the sketch map of the restaurant 72, a photograph 73, address and the like are displayed as the information on the selected restaurant. If the restaurant owns a Web site, an icon (not shown) for linking to the Web site is also displayed.

Registered information is not limited to one type. In this embodiment, if an icon “Simple map display” on the lower part of the screen is clicked on, the simple map showing the location of the restaurant is displayed as shown in FIG. 8.

Next, description will be given to operation if “News” is selected on the main menu.

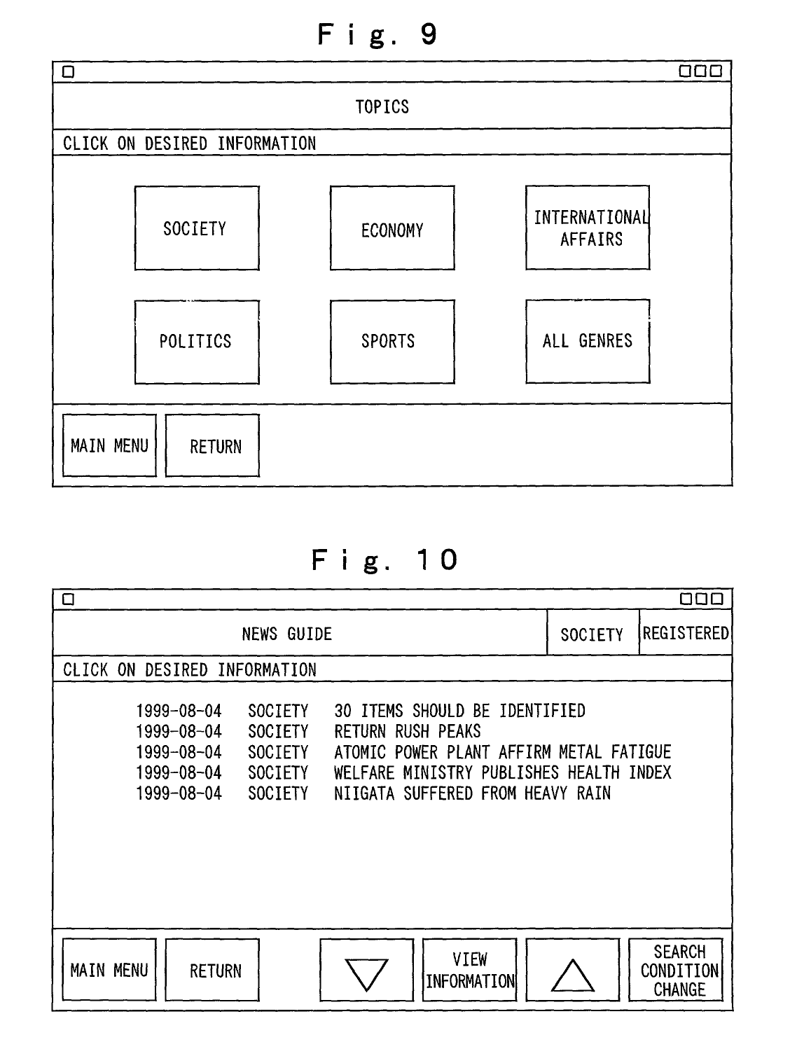

If the icon “News” is clicked on in the step S3, a topic selection screen is displayed in a step S20 as shown in FIG. 9. In this embodiment, six topics of “Society”, “Economy”, “International affairs”, “Politics”, “Sports” and “All genres” are prepared. If the operator clicks on a desired topic in a step S21, the same processing as those described above is carried out in the steps S4 and 5. In this embodiment, description will be given, assuming that the operator clicks on the icon “Society” as a selected topic.

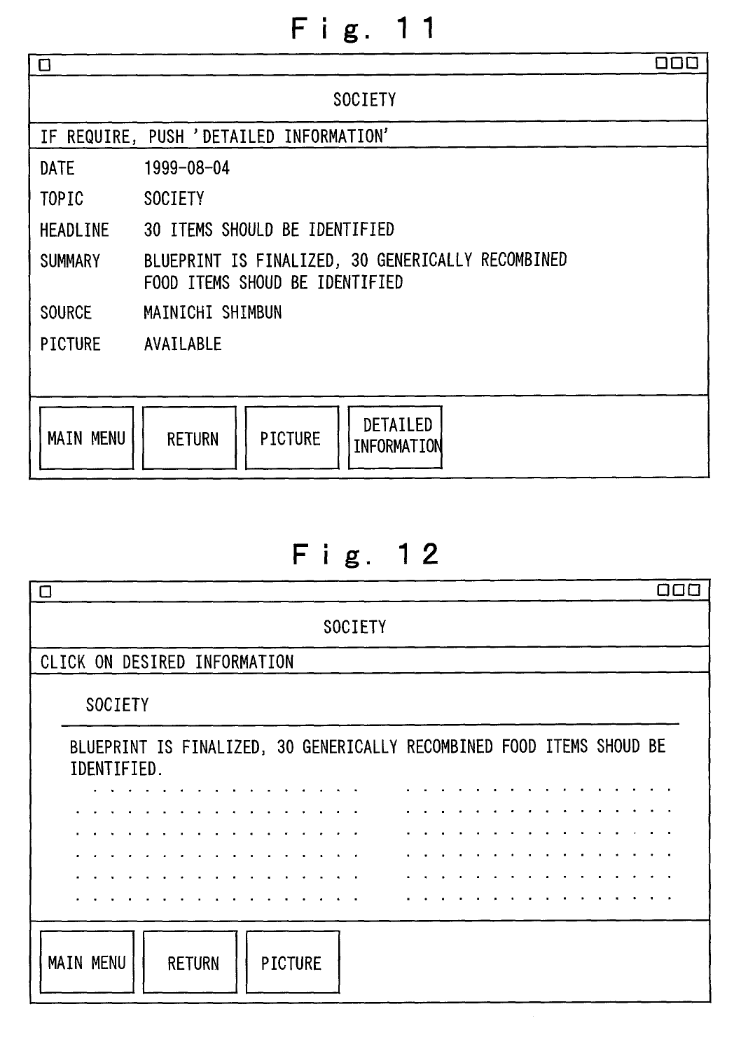

In the step S6, the summaries (headlines) of the topic “Society” are displayed as a list on the display 703 as shown in FIG. 10. If the operator clicks on a headline, for example, “30 items must be identified” in a step S11, all summaries of relevant topics are displayed as shown in FIG. 11 in a step S12. If the operator clicks on the icon “Detailed information” in FIG. 10, the information is displayed on the display 703 as shown in FIG. 12 in a step S18.

According to the present invention, the summaries of a plurality of types of information which have different formats, different transmission methods and the like and which cannot be displayed by a common viewer are described in a common format and the summaries of the respective information are displayed as a list by a single viewer. Thus, it is possible to search and display the contents of the respective information having different formats and different transmission methods with a simple constitution.

Further, if a summary corresponding to desired information is designated from among summaries on a displayed list, a viewer peculiar to the information is automatically selected and the information is displayed thereby. Thus, an operator can view all the information in the same procedures without taking account of the formats of the respective information.

What is claimed is:

1. An information search and display apparatus comprising:
a push type information interface for inputting push type information provided from a push type information distribution medium;
a pull type information interface for inputting pull type information and summaries of the pull type information from a pull type information distribution medium;
summary extraction means for extracting summaries described in a predetermined common format from said respective inputted push type information;
summary storage means for storing said extracted summaries;
search condition input means for inputting search conditions;
summary download means for downloading summaries of pull type information satisfying said search conditions through said pull type information interface, the summaries described in said predetermined common format;
summary search means for searching summaries satisfying said search conditions from the summaries already registered in said summary storage means; and
summary list display means for displaying a list of said searched summaries and the summaries satisfying said search conditions and downloaded from the pull type information distribution medium.

2. An information search and display apparatus according to claim 1, comprising:
information storage means for storing the push type information downloaded from said push type information distribution medium;
summary designation means for designating one of the summaries displayed on the list;
information download means for downloading information corresponding to said designated summary; and
display control means for displaying said downloaded information in a unique form corresponding to a format of the information, wherein
if the information corresponding to said designated summary is the information already registered in said information storage means, said information download means downloads the registered information, and if the information corresponding to said designated summary is unregistered pull type information, said information download means downloads the unregistered pull type information from the pull type information distribution medium through said pull type information interface.

3. An information search and display apparatus according to claim 2, wherein the pull type information downloaded by said information download means is stored in said information storage means.

4. An information search and display apparatus according to claim 1, wherein said push type information distribution medium is broadcasting.

5. An information search and display apparatus according to claim 1, wherein said pull type information distribution medium is at least one of an information providing service utilizing a public line, Internet and a disk medium.

6. An information search and display apparatus according to claim 1, wherein when accessing an information for which an operator is charged for download of said information or summaries, whether to admit or reject the download of the information is inquired in advance.

7. An information search and display apparatus according to claim 6, wherein If access to the charged information is rejected, information from a medium free of charge is set as a search target.

8. An information search and display apparatus according to claim 1, wherein in displaying said list of summaries, a list of only important parts of the respective summaries is displayed.
